(19) United States
(12) Patent Application Publication
(10) Pub. No.: US 2010/0169348 A1
(43) Pub. Date: Jul. 1, 2010

(54) Systems and Methods for Handling Multiple Records

(75) Inventors: Anthony W. Maro, White Sulphur Springs, WV (US); John B. King, White Sulphur Springs, WV (US)

Correspondence Address: MOAZZAM & ASSOCIATES, LLC, 7601 LEWINSVILLE ROAD, SUITE 304, MCLEAN, VA, 22102, US

(73) Assignee: EVRICHART, INC., Roanoke, VA (US)

(21) Appl. No.: 12/347,627

(22) Filed: Dec. 31, 2008

(51) Int. Cl. G06F 17/30

(52) U.S. Cl. 707/758; 707/E17.014

(57) ABSTRACT

Devices and methods are disclosed which relate to identifying ‘duplicate’ records in a database by finding similarities between records and applying a set of heuristic rules to determine a likelihood of being a duplicate record. The weighted results of the application of the heuristic rules identify possible duplicate records in the database. Embodiments of the present invention search records comprising fields of personal information. Matches are found between records and weighted according to the degree of similarity and uniqueness. By taking account of the different modes by which duplication errors typically originate in the database to which the method is applied, these heuristic rules identify a higher percentage of actual duplicate records in the database. The heuristic rules also produce a lower rate of ‘false positives’ than the methods for identifying duplicate records in databases now known in the art.

### BACKGROUND OF THE INVENTION

1. Field of the Invention

The present invention relates to the field of database management. In particular, the present invention relates to identifying duplicate records in databases.

2. Background of the Invention

Hospitals store information relating to patient health history and care in unique records (‘medical records’) identified by a Medical Record Number (MRN). Patients' MRNs are issued through the use of a Master Patient Index (MPI), identifying a patient through the use of biographical information (name, address, social security number, etc) and listing their associated MRN. Typically, when a patient enters the hospital facility, intake personnel try to determine if the patient already has a MRN at that facility and if they do not, assign them a MRN. For example, a staff member might query the MPI based on what they take to be the patient's last name and decide whether or not to assign the patient a new MRN based on their findings.

Human error however often leads to assigning the same individual multiple MRNs and thus multiple sets of records. For example, a spelling error in a patient's last name may lead intake personnel to believe they are facing a new patient when in fact the patient already has a MRN and an associated set of records at that facility. Changing patient biographical information is also a common cause of duplication. For example, a patient may change their last name due to marriage. If there is some doubt about whether or not a patient already has a MRN at a facility, intake personnel often will elect to assign them a new MRN rather than risk assigning them someone else's MRN. Industry estimates of the rate of duplicates in typical MPIs range from 8 to 15%. This has negative implications for quality of care. Duplicate sets of records make it difficult for caregivers to have a comprehensive record of patient treatment. There also is potential hospital liability. If the facility needs to submit documentation to get reimbursed by a health insurance company or the government, poor maintenance of the MPI could lead to fines or delays in payment for patient care. As more facilities switch to Electronic Health Records (EHRs) in place of physical documents and legislation mandates standards for how patient information is maintained, the integrity of hospital MPIs is getting more and more attention.

Hospitals have tried to combat the problem of duplication in their MPIs by manually searching the MPI to look for potential duplicates, but such a process is extremely time consuming and thus expensive. Efforts have been made to use computer algorithms to identify duplicates by looking for exact matches in specific fields between different entries in the MPI. For example, an algorithm might search the MPI and return a list of entries in which the “name” fields are exact matches. Research into the actual process by which duplicates are produced suggests that such methods miss a large fraction of actual duplicates. Additionally, a spelling error may be responsible for a duplicate, producing a large number of false positives such as distinct persons with the same first and last name.

Aside from identifying duplicate records in one MPI, different facilities may need to identify sets of records belonging to the same patient across multiple MPIs. For example, hospital facilities may wish to link their MPIs together into an Enterprise Master Patient Index (EMPI) to facilitate tracking patient care information across the range of facilities in the enterprise. This could require, for each patient, associating his/her MRNs at all the facilities in the enterprise. In another example, two facilities may have to merge their separate MPIs into one common MPI when there is a merger between their parent companies. They will also be required to link or merge sets of records belonging to the same patient. If there are errors or omissions in patients' biographical information, for example, if a social security number is missing or a name is misspelled, an algorithm will be required which goes beyond ‘exact match’ criteria.

There is thus a need for a system which can identify potential duplicates that takes account of the modes by which such duplicates were created in the first place. Such a system will identify a higher percentage of actual duplicates and produce fewer false positives than the algorithms that are currently used to identify duplicates in MPIs. An algorithm must take account of possible errors or omissions in patient biographical information to link sets of records belonging to the same patient.

### SUMMARY OF THE INVENTION

The present invention teaches a method of identifying ‘duplicate’ records in a database by finding similarities between records and applying a set of heuristic rules to determine a likelihood of being a duplicate record. The weighted results of the application of the heuristic rules identify possible duplicate records in the database. Embodiments of the present invention search records comprising fields of personal information. Matches are found between records and weighted according to the degree of similarity and uniqueness. By taking account of the different modes by which duplication errors typically originate in the database to which the method is applied, these heuristic rules identify a higher percentage of actual duplicate records in the database. The heuristic rules also produce a lower rate of ‘false positives’ than the methods for identifying duplicate records in databases now known in the art.

In one exemplary embodiment of the present invention, the method is implemented by importing a hospital's MPI to a database server, putting the records into a standardized form, analyzing the standardized database for possible duplicate records, and sorting the results according to the probability that the records so analyzed are duplicative.

In another exemplary embodiment, the present invention is a method for identifying potential duplicate records among a plurality of records in a database of personal information, the personal information corresponding to a plurality of fields in each record, comprising finding one or more matches between fields from a pair of records, assigning a weight to each match according to a plurality of heuristic rules, and determining a likelihood that the pair of records are duplicative based on the matches. The likelihood is calculated from the weights assigned to each match.

In a further exemplary embodiment, the present invention is a system for identifying potential duplicate records in a database, comprising a database comprising a plurality of records, a server in communication with the database, a logic on the server, and a means of output in communication with the server. The logic finds a plurality of matches in one or more duplication analysis passes through the database, applies a plurality of heuristic rules to determine a likelihood that any records in the database are duplicative, and outputs the likelihood.

In yet another exemplary embodiment, the present invention is a method for identifying potential duplicate records among a plurality of records, comprising finding a plurality of matches in one or more duplication analysis passes through the plurality of records, applying a plurality of heuristic rules to determine a likelihood that any two records in the plurality of records are duplicative, and outputting any records likely to be duplicates. The plurality of matches includes exact matches, inexact matches, and generic matches.

### BRIEF DESCRIPTION OF THE DRAWINGS

FIG. 1 shows typical records in a database, according to an exemplary embodiment of the present invention.

FIG. 2 shows a system for identifying duplicate records, according to an exemplary embodiment of the present invention.

FIG. 3 displays a flow chart illustrating schematically how the present invention analyzes a database to identify potential duplicate records, according to an exemplary embodiment of the present invention.

FIG. 4 shows an exemplary embodiment of a potential duplicates report.

FIG. 5 shows an overall summary report, according to an exemplary embodiment of the present invention.

FIG. 6 shows a combination of two separate databases that have been merged through duplication analysis into a single database, according to an exemplary embodiment of the present invention.

### DETAILED DESCRIPTION OF THE INVENTION

The present invention teaches a method of identifying ‘duplicate’ records in a database by finding similarities between records and applying a set of heuristic rules to determine a likelihood of being a duplicate record. The weighted results of the application of the heuristic rules identify possible duplicate records in the database. Embodiments of the present invention search records comprising fields of personal information. Matches are found between records and weighted according to the degree of similarity and uniqueness. By taking account of the different modes by which duplication errors typically originate in the database to which the method is applied, these heuristic rules identify a higher percentage of actual duplicate records in the database. The heuristic rules also produce a lower rate of ‘false positives’ than the methods for identifying duplicate records in databases now known in the art.

As used in this disclosure, a ‘duplicate’ record in a database means a record in a database that refers to an object that another record in the database also refers to. For example, in an exemplary embodiment of the present invention, the method acts on a database of records in a hospital MPI. A record is said to be ‘duplicate’ if it refers to a person that another record in the same database also refers to.

“Match,” as used herein, refers to the correlation of a personal information datum of one record to a personal information datum of another record. Examples of a match are the same name, same address, same birth date, same city, etc. Furthermore, matches can be exact, inexact, or generic.

An “exact match” occurs when the datum of one record is identical to the datum of another record, unless the datum is found to be generic.

An “inexact match” occurs when the datum of one record is similar to the datum of another record. Examples of an inexact match include two records with the same name, but different variations such as John and Jon or Bill and William. Other examples of inexact matches include dates or numbers that are off by one or two digits.

A “generic match” occurs when the datum of two records is blank, or some generic identifier which would otherwise result in an exact match. Examples of generic matches include blank data, social security numbers reading 999-99-9999 or some other response that is not a real social security number.

In one embodiment of the present invention, the method is implemented by importing a hospital's MPI to a database, putting the records into a standard form, and analyzing the standardized database for possible duplicate records and sorting the results according to the likelihood that the records so analyzed are duplicative.

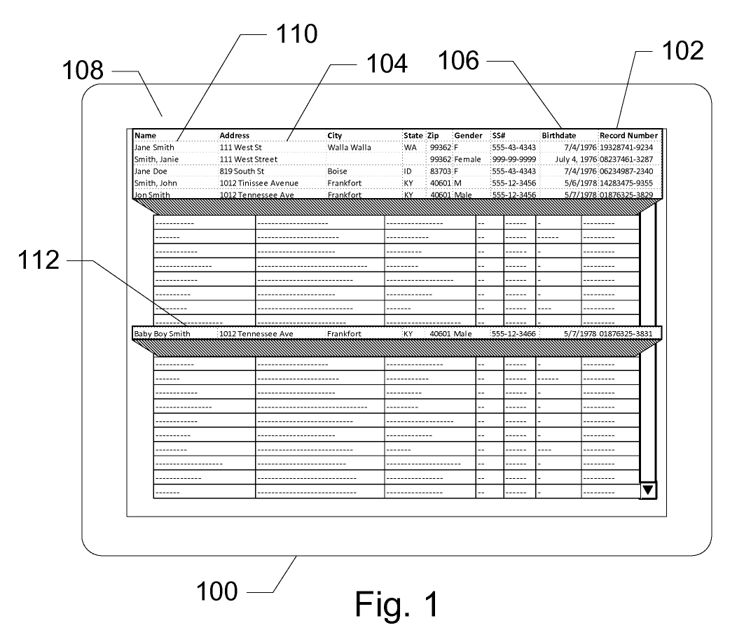

FIG. 1 shows typical records 102 in a database 100, according to an exemplary embodiment of the present invention. Database 100 is composed of cells 104 which contain data 106. Cells 104 are grouped by row into records 102 and by column into fields 108. Records 102 are understood to refer to objects outside of database 100 through data 106 contained in records 102. In an exemplary embodiment of the present invention, database 100 to which the method is applied is an MPI assigning patients their MRNs. Alternatively, database 100 is a database whose records contain enough information to, by themselves, identify a unique object outside of the database and for which it is desired to find records which identify the same object. For example, database 100 may be a database of subscribers to a magazine or a database of billing account entries. In an embodiment of the present invention, records 102 refer to patients at the hospital through identifying biographical information (i.e., name, birth date, social security #, etc) and assign them MRNs.

Database 100 contains potential duplicate records 110. Database 100 contains several potential duplicate records 110, i.e., separate entries for “Jane Smith” and “Smith, Jane” and separate entries for “Smith, John”; ““Jon Smith”; and “Jack Smith”. A method for identifying duplicates that relied on exact matches between fields will miss all of these potential duplicate records 110. For example, none of the fields of the “Smith, Jane” and “Jane Smith” records are exact matches. The name “baby boy” shows an example of a generic entry 112 shown midway down the MPI. Even though it is not even close to a match, the name field should not be disregarded because “baby boy” can be an equivalent of any male record with a last name of Smith.

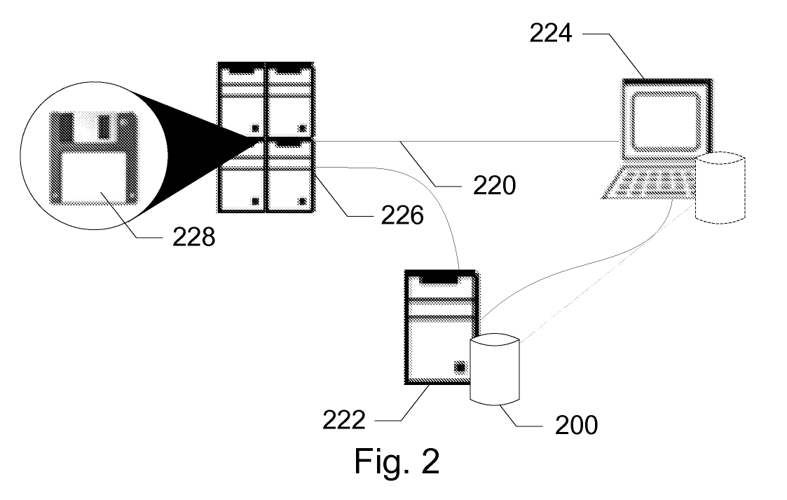

FIG. 2 shows a system for identifying duplicate records, according to an exemplary embodiment of the present invention. In this embodiment, the system includes a local area network 220, a database 200, a database server 222, a user computer 224, and a processing computer 226 with a logic 228. Database 200 is uploaded to database server 222 at user computer 224. User computer 224 is any network device at which a user of local area network 220 can send a database file to database server 222. For convenience, user computer 224 has a web interface to upload the database file to database server 222. In this embodiment, database server 222 communicates with processing computer 226 over local area network 220. Preferably, processing computer 226 is a high performance computer to cut down on processing time, although processing computer 226 can be any network device capable of implementing an algorithmic formulation of the present invention. Processing computer 226 uses logic 228 to find potential duplicate records, then outputs potential duplicate records it identifies to user computer 224 via local area network 220. In alternative embodiments, the processing computer is unnecessary, with the server providing the same functions through the use of logic 228.

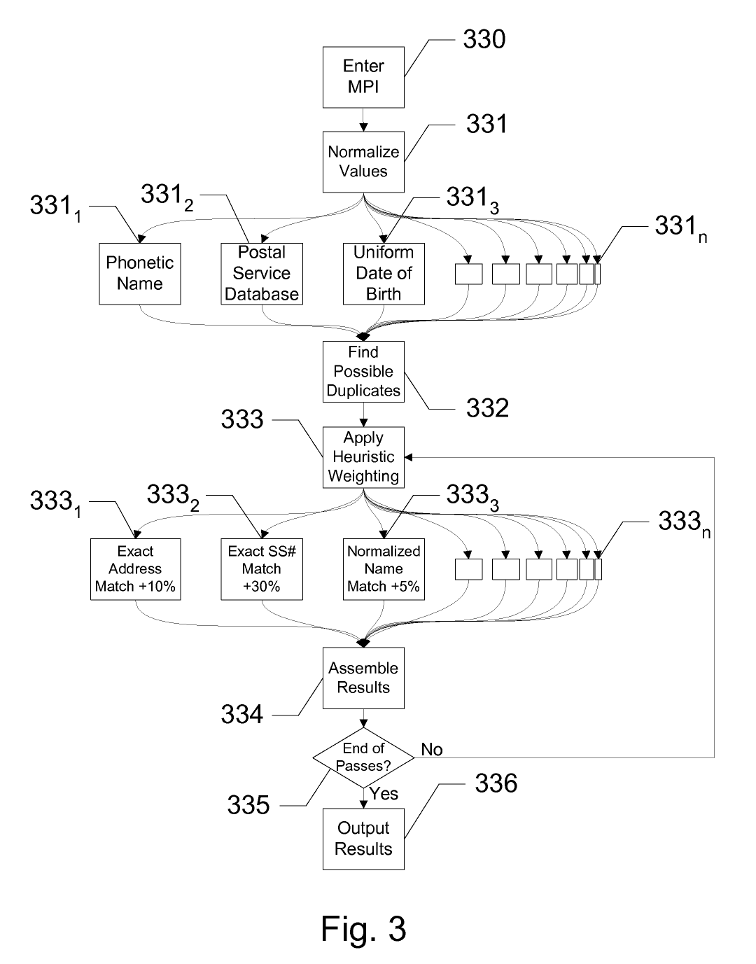

FIG. 3 displays a flow chart illustrating schematically how the present invention analyzes a database to identify potential duplicate records, according to an exemplary embodiment of the present invention. In this embodiment, a hospital or other health facility enters an MPI to find and eliminate duplicate records 330. To accommodate databases from various sources, a standardization protocol normalizes the data in the database, putting the database in a standard form 331. Standard form changes depending on the type of database, but can have many sub-standardizations 331₁-331ₙ, including multiples for each field. Depending on the field and the data encountered, in some embodiments the standardization protocol resets cells to be blank, inserts meta-data into the cells indicating that the cell's datum is generic or invalid, or segregates the associated record to a specific part of the database. The part of the database the record is segregated to depends on the field and the data encountered.

The MPI in this embodiment includes a field that corresponds to patient name and another field that corresponds to patient home address. A standard form method parses the data in a field corresponding to a patient name for a first, last, and middle name (if present). Alternatively, the standardization protocol parses both data of the form “first name last name” as in “Jane Smith” and data of the form “last name, first name” as in “Smith, Jane” and places the first and last names obtained in separate fields for first and last name in the standardized database. The standardization protocol can use a look-up table of common titles (Dr, Prof., Sir, Esq., etc) to drop non-name data in the “name” field from the database 331₁. The standardization protocol converts any of the various designations for roads in street addresses into standard postal form, for example, converting “street” into “st” or “avenue” into “ave” 331₂. The standardization protocol converts any dates of the form “Name of Month Day, Year” into the form “Number of Month/Day/Year”. The standardization protocol converts “Jul. 4, 1976” into “7/4/1976” 331₃ or any other standard numerical format.

In this embodiment, the data of the subset of fields to be checked against another database represents social security numbers to be checked against a database of all valid social security numbers to identify invalid social security numbers. Then the associated records are output to a separate report. In a further embodiment, the standardization protocol is set to recognize generic data for a social security number and re-set it to be blank, insert meta-data into the cell indicating that the social security number is generic, or segregate the associated record to a specific part of the database. For example, it is common practice at some hospitals to enter “999999999” as the value of an unknown patient social security number.

Once the database has been normalized, a multi-pass duplication analysis checks the database for possible duplicates 332. The multi-pass duplication analysis consists of a number of duplication analysis passes of increasing analytical complexity through database.

Each duplication analysis pass applies a set of heuristic rules 333₁-333ₙ to all or some subset of fields of the database 333. Certain types of matches are given different weights, depending on the closeness of the match as well as the field matched. A ‘heuristic rule’ is any measure for determining the extent to which given relationships of similarity (i.e., “exact” matches, “inexact” matches, “generic” matches, etc) between pieces of data implies identity of the objects referred to by the records associated with the pieces of data. The weight value can be positive, negative, or 0. The weight value assigned to a pair of cells in a duplication analysis pass is determined by heuristic rules used by that particular duplication analysis pass. In some embodiments, heuristic rules 333₁-333ₙ can account for the presence of meta-data, signifying invalid or generic data in either of the cells to be compared. After the heuristic weighting is applied, the results are assembled 334. Summing up the weights determines a weight value for each pair of record cells in fields to be analyzed. The system then queries whether any more passes will be made 335. Each subsequent pass may allow for more slight differences in the data and generally are given less weight than earlier passes. If more passes are needed, the method returns to the heuristic weighting step 333. If no more passes are required or desired, the results are output 336. When the multiple-pass analysis is completed, all pairs of records whose duplication scores exceed a predetermined threshold are output to the potential duplicates report. Other data produced by the standardization protocol or the multi-pass analysis of the database can be output to the potential duplicates report as well.

In an exemplary embodiment of the present invention, the heuristic rules 333₁-333ₙ are designed to account for the actual processes by which duplicate records might have been introduced to database. At the end of first duplication pass, for every pair of records, a duplication score is determined by summing all the weight values produced by the application of heuristic rules of first duplication pass to the pair of records. For each of the remaining duplication analysis passes, a heuristic rule is applied to a pair of cells only if the pair of cells meets certain conditions. For example, duplication score for an associated pair of records must fall above a threshold, which changes depending on the heuristic rule applied. Such a feature is useful in cutting down on the number of comparisons between possible duplicate records when the first duplication analysis pass suggested a low likeliness to be duplicate. In this embodiment where the database is an MPI, such a circumstance may occur if the pair of records to be compared disagrees in the “gender” field and the “birth date” field. Whenever a heuristic rule is applied to the pair of cells for remaining duplication analysis passes, the weight value determined replaces the prior weight value for that pair of cells and duplication score for associated pair of records is updated.

In a further embodiment of the present invention, a heuristic rule is applied to a pair of cells only if the sum of the maximum weight value of that heuristic rule, and any remaining heuristic rules that have yet to be executed for its duplication analysis pass, exceed a threshold. This threshold determines the minimum duplication score for any pair of records to be included in a potential duplicates report.

In an exemplary embodiment of the present invention, the heuristic rules of the first duplication analysis pass check for exact matches in all fields of the database, assigning positive weight values to pairs of cells for exact matches and a negative weight value if a pair of cells corresponding to personal identification numbers do not match. These personal identification numbers can be social security numbers.

In an exemplary embodiment of the present invention, the heuristic rules of the subsequent duplication analysis passes assign weight values based on the extent to which pairs of cells whose data are proper nouns match. These weights depend upon whether the matches are phonetic matches and the extent to which pairs of cells whose data are numbers are fuzzy matches. The heuristic rules of the subsequent duplication analysis passes use the Soundex algorithm to determine the extent to which any data in fields whose contents are names match phonetically. The Soundex algorithm is also used to determine the extent to which any proper noun data in fields whose contents are home addresses match phonetically, assigning weight values accordingly. The assigned values are below the weight values assigned if the data of those fields match exactly. Because the Soundex algorithm works optimally for matching spellings of names associated with certain nationalities, other phonetic matching algorithms have been developed. For example, “Daitch-Mokotoff” Soundex was developed to optimally match spellings of Eastern European surnames. The Soundex algorithm is applied to name fields during an early duplication analysis pass while other varieties of Soundex are applied to name fields in later duplication analysis passes. For example, different Soundex varieties can be used based upon the demographics (i.e., Eastern European, Hispanic, etc) of the database.

In a further exemplary embodiment, for any two cells in a field whose data are numbers that match except for 1 or 2 digits, the heuristic rules of a subsequent duplication analysis pass assign a positive weight value. The weight value remains below the weight value assigned in the first duplication analysis pass when the data of those two cells matched exactly.

In an exemplary embodiment of the present invention, for certain fields, the heuristic rules can adjust the weight values assigned to pairs of cells based on the number of matches found for one of those cells. This feature is useful in preventing the invention from assigning too much significance to matches that are common, even for distinct records. For example, two records that share a common name (“John Smith”) are far less likely to be duplicate records than two records that share an uncommon name. For each cell to be checked against all other cells in a particular duplication analysis pass, the method of this embodiment tracks the number of matches found and adjusts the weight values downward for every matching pair based on this number of matches.

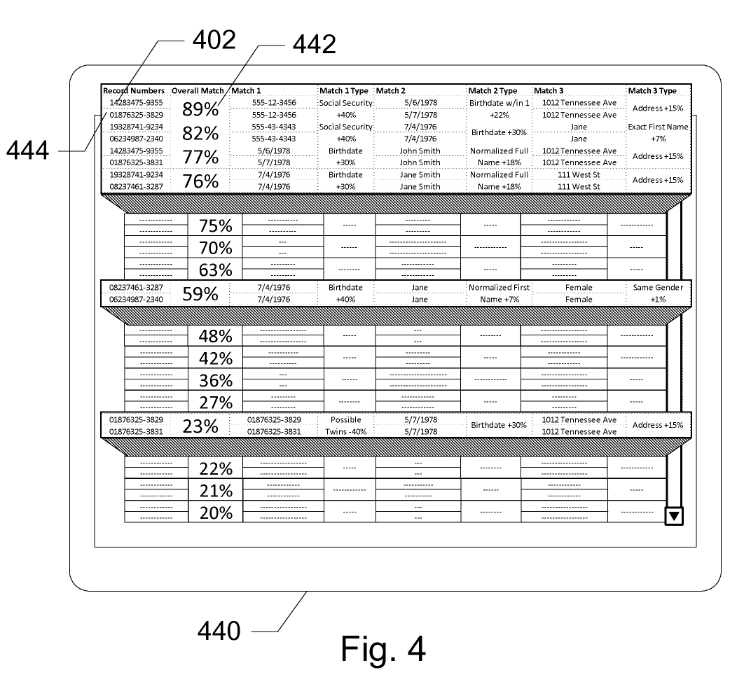

FIG. 4 shows an exemplary embodiment of a potential duplicates report 440. In this exemplary embodiment, potential duplicates report 440 is a spreadsheet displaying duplication scores 442 for pairs of records 444 sorted by decreasing duplication score 442 and tabbed with ranges of duplication scores 442. In this embodiment, all records 402 with invalid data identified during standardization protocol are reported in a separate section of potential duplicates report 440.

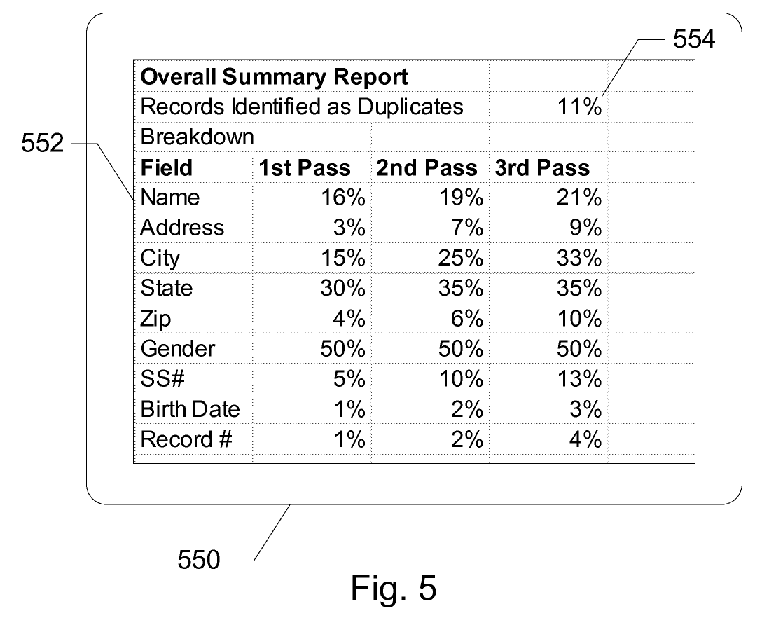

FIG. 5 shows an overall summary report 550, according to an exemplary embodiment of the present invention. Overall summary report 550 shows the percentage of duplicates identified by each duplication analysis pass for all or some subsets of fields 552 and the overall incidence of potential duplicate records 554 in the database. In embodiments in which the standardization protocol sets cells containing generic data to be blank, the invention replaces any blank cells in the database with the data originally contained.

The method of the present invention gives it the ability to account for the particular modes by which duplicate entries are introduced into the database in the first place. Accordingly, the heuristic rules can be tuned to account for idiosyncrasies in the manner in which data is entered into the database.

In an exemplary embodiment, generic data for certain fields can be identified in the standardization protocol and treated differently by the heuristic rules than other data in those fields. Generic names are often introduced into MPIs, for example, when the patient name is unknown or undefined. For example, a newborn girl may not yet have been assigned a name by her parents and hospital procedure may be to assign such patients the generic first name “baby girl”. Other examples of generic names that may be found in a hospital MPI might be “baby boy”, “John Doe” or “Jane Doe”. A further generic entry that may be found in a hospital MPI is “999999999” for an unknown social security number. In an exemplary embodiment of the present invention, the standardization protocol can segregate such records in specific parts of the database. This segregation may be based on the value of the generic datum and the field in which such a generic datum occurs. For example, all “baby boy” records can be grouped together at the end of the database after all records that have been identified as having invalid social security numbers, all “John Doe” records after the “baby boy” records, etc. In another exemplary embodiment, all such segregated records are listed and totaled by generic name in a separate section of the potential duplicates report.

The heuristic rules account for the presence of generic data in a field by setting the weight value between any cell whose datum is generic and any other cell to be equal to the default value of such a weight. Such a feature can be facilitated by segregating all records containing generic data in specific parts of the database. When a heuristic rule of this embodiment is applied to a cell whose position in the database indicates it contains generic data, it sets the weight value between that cell and any other cell equal to a default weight value. In another embodiment, the standardization protocol resets the cells containing generic data into blanks and the heuristic rules set the weight value between any blank cell and any other cell to equal to a default weight value. In another embodiment, the standardization protocol inserts meta-data into any cell containing generic data while the heuristic rules are encoded to detect such meta-data and set the weight value between any such cell and any other cell equal to a default weight value.

In a further exemplary embodiment where database is an MPI, a “twin detector feature” is encoded. This is included so that two records each containing generic data in a field corresponding to a patient name whose duplication score is above the threshold for inclusion in the potential duplicates score report but whose MRNs are within five digits of each other have their duplication score decreased. These two records are not included in the portion of the potential duplicates report where potential duplicate records are listed. Such a feature is designed to prevent inclusion in the potential duplicates report of the not uncommon circumstance where twin babies are born and have been assigned generic names. Twins have much biographical data in common, but their records obviously do not correspond to duplicate entries in the MPI.

An alternative embodiment of the present invention furnishes an improved method to query a database to determine if an input record has a potential duplicate in the database. The user computer uploads an individual record to the database server already loaded with a database, and the processing computer returns a list of potential duplicates for that individual record. This embodiment provides a method for intake personnel to make accurate initial determinations as to whether or not a new patient already has an MRN at that facility.

An alternative embodiment of the present invention furnishes an improved method to create a single database from a set of separate databases, some of whose records identify the same unique object. In such an embodiment, the output of the processing computer is a single database and a duplication score report. The duplication score report contains only pairs of records whose duplication score falls above a pre-set threshold.

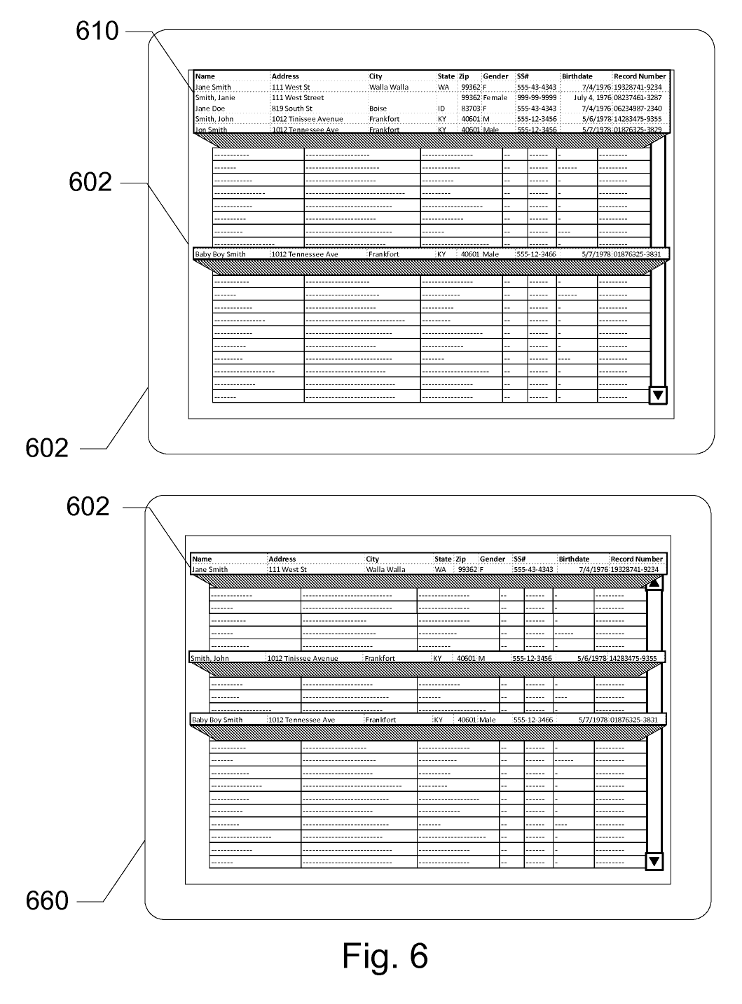

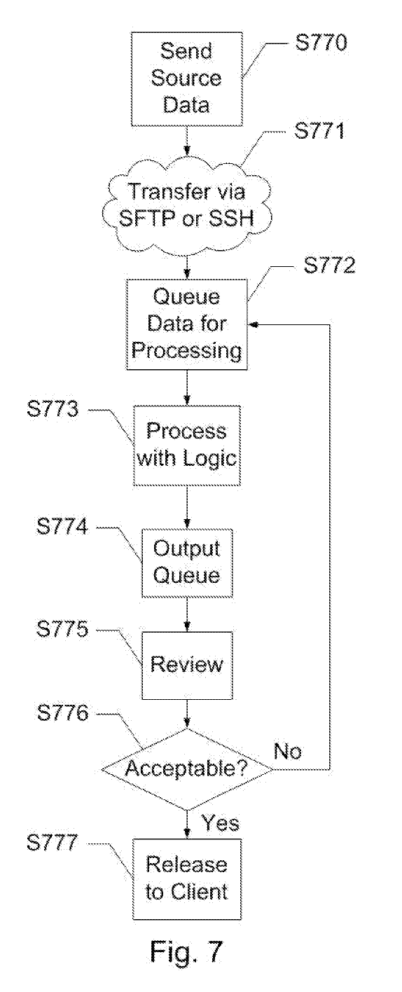

FIG. 6 shows a combination of two separate databases 602 that have been merged through duplication analysis into a single database 660, according to an exemplary embodiment of the present invention. The single database contains all records 602 whose duplication scores all fall below a threshold. Those potential duplicate records 610 whose duplication score exceeds the threshold are listed together in the single database 660. This embodiment presumes that pairs of records whose duplication scores exceed the threshold are certain to identify the same object and isolates the potential duplicate records 610 in the duplication score report for further investigation.

Quality control and secure transfer is important when handling sensitive information such as a hospital MPI. Secure transfer of the MPI helps maintain privacy of the information while a review by personnel ensures that duplicate results are satisfactory before returning the MPI to a client.

FIG. 7 shows a flow chart of a process of handling a client master patient index, according to an exemplary embodiment of the present invention. A client first sends their source data to be filtered of duplicates S770. Transfer of the source data takes place over a secure file transfer protocol (SFTP) or secure shell (SSH) over a digital connection such as the INTERNET S771. Once the source data is received it is placed into a queue S772. When its queue is up, a logic processes the source data and finds potential duplicates S773. When all the potential duplicates are found, the source data is placed in an output queue S774. The source data remains in the output queue until someone reviews the potential duplicates for validity S775. If the results are acceptable S776, then the potential duplicates and source data is sent back to the client S777. If the results are unacceptable S776, the source data is placed back in the queue for data processing again.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for identifying potential duplicate records among a plurality of records in a database of personal information, the personal information corresponding to a plurality of fields in each record, comprising:
finding one or more matches between fields from a pair of records;
assigning a weight to each match according to a plurality of heuristic rules; and
determining a likelihood that the pair of records is duplicate based on the matches;
wherein the likelihood is calculated from the weights assigned to each match.

2. The method of claim 1, further comprising converting fields into a standard form.

3. The method of claim 2, wherein converting an address field comprises comparing the address field with a postal service database and replacing the address field with a standard postal form.

4. The method of claim 2, wherein converting a birth date field comprises replacing the birth date field with a standard numerical format.

5. The method of claim 1, wherein finding a match comprises finding exact matches and inexact matches.

6. The method of claim 1, wherein finding uses a phonetic matching algorithm on fields whose data are words.

7. The method of claim 1, wherein assigning further comprises giving more weight to an exact match than an inexact match.

8. The method of claim 1, wherein assigning further comprises giving less weight to a generic match than an inexact match.

9. A system for identifying potential duplicate records in a database, comprising:
a database comprising a plurality of records;
a server in communication with the database;
a logic on the server; and
a means of output in communication with the server;
wherein the logic finds a plurality of matches in one or more duplication analysis passes through the database; applies a plurality of heuristic rules to determine a likelihood that any records in the database are duplicative; and outputs the likelihood.

10. The system in claim B, wherein the database is an MPI and the plurality of records each include patient biographical information and the MRN assigned to the patient.

11. The system in claim 9, wherein the means of output is one of a monitor, printer, and facsimile.

12. A method for identifying potential duplicate records among a plurality of records, comprising:
finding a plurality of matches in one or more duplication analysis passes through the plurality of records;
applying a plurality of heuristic rules to determine a likelihood that any two records in the plurality of records are duplicative; and
outputting any records likely to be duplicate;
wherein the plurality of matches includes exact matches, inexact matches, and generic matches.

13. The method of claim 12, further comprising converting the plurality of records into a standard form.

14. The method of claim 12, wherein the outputting further comprises sorting by likelihood of being duplicative.
